(19) United States
(12) Patent Application Publication
(10) Pub. No.: US 2011/0296754 A1
(43) Pub. Date: Dec. 8, 2011

(54) Light-permeable Pot and Decorative Tree Using Such Pot

(76) Inventor: Cai Jun Hao, GUANGDONG PROVINCE (CN)

(21) Appl. No.: 12/982,851

(22) Filed: Dec. 30, 2010

(51) Int. Cl. A01G 9/02

(52) U.S. Cl. 47/65.7

(57) ABSTRACT

The utility model discloses a light-permeable pot, which comprises a pot main unit. The foresaid main unit has a bottom and a side wall, and the upper part is an open-end. Part or all of the foresaid side wall of the pot is light-permeable components; by making the walls of the pot with light-permeable components, parts of the luminous tube can be placed in the trunk in the pot when setting string light. After power-on, the light from the luminous tubes in the pot can pass through the light-permeable components of the side walls to achieving better luminous effect and decorative effective of the decorative trees.

### BACKGROUND OF THE INVENTION

The utility model relates to a luminous decorative article, in particular to a light-permeable pot. This utility model also relates to a decorative tree using such light-permeable pot.

Currently, many decorative articles are set on a pot, such as decorative tree and Christmas tree. Some trees are enwound with luminous string light. Because the main unit of the pot is light-impermeable, the lumination from the string light can't be seen in the pot causing poor decorative effect.

### BRIEF SUMMARY OF THE INVENTION

This invention is to provide a light-permeable pot, comprising a main unit. The foresaid main unit has a bottom and a side wall, and the upper part is an open-end. Part or all of the foresaid side wall of the pot is light-permeable components.

In the foresaid light-permeable pot, the side wall of the foresaid main unit is round in structure. The round side wall is equipped with couples of light hole with certain intervals. The light holes are covered by light-permeable components.

In the foresaid light-permeable pot, the side wall of the foresaid main unit is a ring in structure. The side wall of the ring is equipped with a cricoid light-permeable component.

In the foresaid light-permeable pot, the side wall of the foresaid main unit is a polygon in structure. Each side of the polygon is equipped with light holes, and light holes are covered by light-permeable components.

In the foresaid light-permeable pot, the side wall of the foresaid main unit is an ellipse in structure. The ellipse side is equipped with a cricoid light-permeable component.

This invention is to provide a decorative tree using the light-permeable pot. The foresaid decorative tree has a seat capable to be mounted on the bottom of the foresaid light-permeable pot. The decorative tree is equipped with string light. Parts of the luminous tube in the string light enwind the trunk in the foresaid light-permeable pot or the seat. Part of all of the side walls of the pot are light-permeable components.

Advantages of the utility mode: by making the walls of the pot with light-permeable components, parts of the luminous tube can be placed in the trunk in the pot when setting string light. After power-on, the light from the luminous tubes in the pot can pass through the light-permeable components of the side walls to achieving better luminous effect and decorative effective of the decorative trees.

### BRIEF DESCRIPTION OF THE DRAWINGS

FIG. 1 shows the structure of light-permeable pot in embodiment 1 of the invention;

FIG. 2 shows the structure of light-permeable pot in embodiment 2 of the invention.

### DETAILED DESCRIPTION OF THE INVENTION

### Embodiment 1

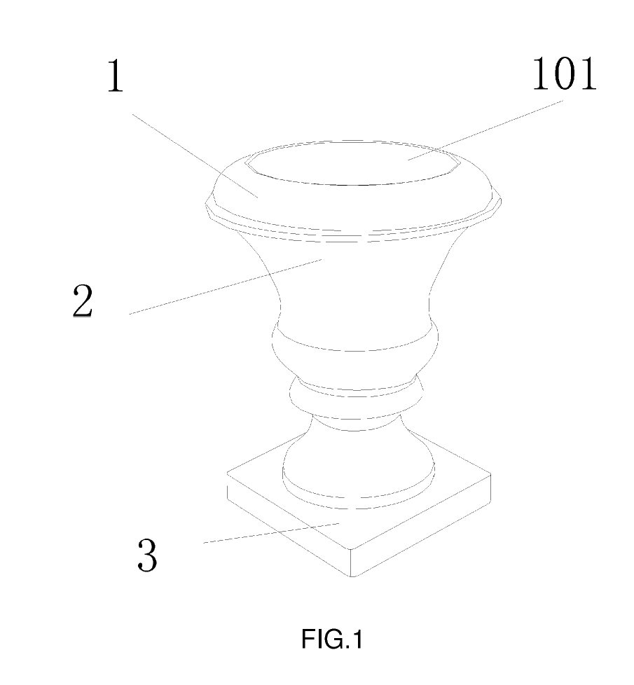

As shown in FIG. 1, it is to design a light-permeable pot comprising a main unit 1. The foresaid main unit has a bottom 3 and a side wall 2, and the upper part is an open-end 101. The foresaid side wall 2 of the pot is a cricoid light-permeable component, and the side wall 2 can also be made into a light-permeable component at certain intervals.

In the foresaid light-permeable pot, the side wall 2 of the foresaid main unit 1 is round in structure. The round side wall is equipped with couples of light hole with certain intervals. The light holes are covered by light-permeable components.

In the foresaid light-permeable pot, the side wall of the foresaid main unit 1 is an ellipse in structure. The ellipse side is equipped with a cricoid light-permeable component.

### Embodiment 2

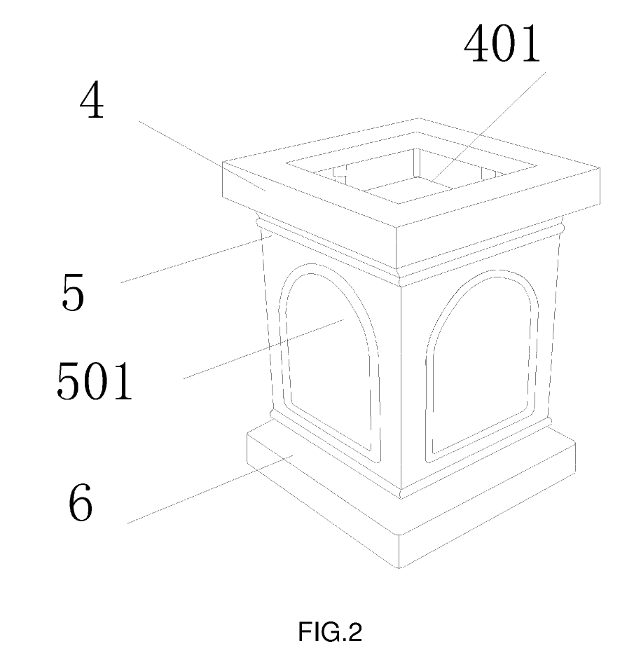

As shown in FIG. 2, it is to provide a light-permeable pot with a bottom 6 and main unit 4. The side wall 5 of the foresaid main unit 4 is a polygon in structure. Each side of the polygon is equipped with light holes 501, and the light holes 501 are covered by light-permeable components.

It is to design a decorative tree using the foresaid light-permeable pot. The foresaid decorative tree has a seat capable to be mounted on the bottom of the foresaid light-permeable pot. The decorative tree is equipped with string light. Parts of the luminous tube in the string light enwind the trunk in the foresaid light-permeable pot 1 or the seat.

What is claimed is:

1. A light-permeable pot, comprises a main unit, the foresaid main unit has a bottom and a side wall, and the upper part is an open-end, part or all of the foresaid side wall of the pot is light-permeable components.

2. The light-permeable pot as set forth in claim 1, characterized in that: the side wall of the foresaid main unit is round in structure, the round side wall is equipped with couples of light hole with certain intervals, the light holes are covered by light-permeable components.

3. The light-permeable pot as set forth in claim 1, characterized in that: the side wall of the foresaid main unit is a ring in structure, the side wall of the ring is equipped with a cricoid light-permeable component.

4. The light-permeable pot as set forth in claim 1, characterized in that: the side wall of the foresaid main unit is a polygon in structure, each side of the polygon is equipped with light holes, and light holes are covered by light-permeable components.

5. The light-permeable pot as set forth in claim 1, characterized in that: the side wall of the foresaid main unit is an ellipse in structure, the ellipse side is equipped with a cricoid light-permeable component.

6. A decorative tree using the light-permeable pot as set forth in claim 1, characterized in that: the foresaid decorative tree has a seat capable to be mounted on the bottom of the foresaid light-permeable pot, the decorative tree is equipped with string light, parts of the luminous tube in the string light enwind the trunk in the foresaid light-permeable pot or the seat, part of all of the side walls of the pot are light-permeable components.
